(19) United States
(12) Patent Application Publication
(10) Pub. No.: US 2018/0020770 A1
(43) Pub. Date: Jan. 25, 2018

(54) METHOD OF MAKING A BREATHABLE, WINDPROOF AND WATERPROOF VAMP FOR A SHOE

(71) Applicants: SHUANG BANG INDUSTRIAL CORP., Nantou City (TW); HUGE DEVELOPMENT LIMITED, Kwun Tong (HK)

(72) Inventors: Chung-Tang CHANG, Nantou City (TW); Ho-Pin LIN, Taichung City (TW)

(21) Appl. No.: 15/218,504

(22) Filed: Jul. 25, 2016

(51) Int. Cl. A43B 7/12; A43D 3/14; A43B 13/28; B29C 65/00; B32B 37/18; B32B 7/14; B29C 65/48; B32B 38/00; B32B 5/02; A43B 23/02; B32B 37/12

(52) U.S. Cl. CPC A43B 7/12; A43B 23/026; A43B 23/0205; A43D 3/1433; A43B 13/28; B29C 66/0326; B32B 37/1292; B32B 7/14; B29C 65/4815; B29C 66/7292; B32B 38/0004; B32B 5/02; B32B 37/182; B29C 66/21; B29C 66/7318; B32B 2307/726; B32B 2307/712; B32B 2437/02; B29L 2031/505

(57) ABSTRACT

A method of making a breathable and windproof vamp includes: (a) providing outer and inner fabric layers; (b) forming a breathable and windproof resin layer on one of the outer fabric layer and the inner fabric layer; (c) dispensing a plurality of spaced-apart glue dots on the resin layer or on the other one of the outer fabric layer and the inner fabric layer; (d) connecting the inner and outer fabric layers in such a manner that the glue dots and the resin layer are interposed between the inner and outer fabric layers, and the inner and outer fabric layers are adhered with each other through the spaced-apart glue dots so as to obtain a fabric laminate; and (e) cutting and forming the fabric laminate into a vamp.

### FIELD

The disclosure relates to a method of making a breathable and windproof vamp for a shoe.

### BACKGROUND

Conventionally, a vamp for shoes having an air permeability greater than 50 CFM (ft³/min) is considered air permeable but has no windproof and warming effects. Thus, when wearing such type of vamp in a cold environment, cold air may enter into the vamp, and the user's feet may feel cold.

In order to prevent the aforementioned problem, a warm layer having a considerable thickness may be introduced between the outer layer and the inner layer of the vamp to achieve the windproof and warming effects. This warm layer may be made from a resin material such as synthetic rubber (Neoprene) foam or ethylene-vinyl acetate copolymer (EVA) foam. The outer layer, warm layer and inner layer are stacked respectively and attached through a continuous adhesive layer to obtain a fabric laminate that is windproof and can keep the user's feet warm.

However, the vamp with the warm and adhesive layers may be air impermeable and relatively heavy to the user's feet. For instance, when the user wears the vamp for a period of time, moisture may build up inside the vamp and the user's feet may feel hot, humid and uncomfortable.

### SUMMARY

Therefore, an object of the disclosure is to provide a method of making a breathable and windproof vamp for a shoe that can alleviate at least one of the drawbacks of the prior art.

According to the disclosure, the method of making a breathable and windproof vamp for a shoe includes the steps of:

(a) providing an outer fabric layer and an inner fabric layer, each of the outer fabric layer and the inner fabric layer having a top surface and a bottom surface that is opposite to the top surface;

(b) forming a breathable and windproof resin layer on one of the bottom surface of the outer fabric layer and the top surface of the inner fabric layer;

(c) dispensing a plurality of spaced-apart glue dots on the resin layer or on the other one of the bottom surface of the outer fabric layer and the top surface of the inner fabric layer;

(d) connecting the inner fabric layer and the outer fabric layer in such a manner that the glue dots 5 and the breathable and windproof resin layer 30 are interposed between the inner fabric layer and the outer fabric layer, and the inner fabric layer and the outer fabric layer are adhered with each other through the spaced-apart glue dots so as to obtain a breathable and windproof fabric laminate; and

(e) cutting and forming the breathable and windproof fabric laminate into a vamp that is formed with a receiving space for receiving a user's foot.

Another object of the disclosure is to provide a method for making a breathable and windproof shoe that can alleviate at least one of the drawbacks of the prior art.

According to the disclosure, the method for making a breathable and windproof shoe includes the steps of:

preparing a breathable and windproof vamp according to the aforementioned method; and

disposing a shoe tree in the receiving space of the vamp for maintaining a configuration of the vamp;

attaching a shoe sole to a bottom of the vamp; and

removing the shoe tree from the receiving space.

### BRIEF DESCRIPTION OF THE DRAWINGS

Other features and advantages of the disclosure will become apparent in the following detailed description of the embodiment with reference to the accompanying drawings, of which:

FIG. 1 is a flowchart illustrating the embodiment of a method of making a breathable and windproof vamp for a shoe according to the disclosure;

FIG. 2 is a perspective view showing an inner fabric layer and an outer fabric layer used in step (a) of the embodiment;

FIG. 3 is a fragmentary sectional view illustrating step (b) of the embodiment;

FIG. 4 is a perspective view illustrating step (c) of the embodiment;

FIG. 5 is a fragmentary sectional view illustrating step (d) of the embodiment;

FIG. 6 is a perspective view illustrating step (e) of the embodiment;

FIG. 7 is a perspective view illustrating the vamp made by the embodiment;

FIG. 8 is a schematic view illustrating disposing a shoe tree in a receiving space of the vamp; and

FIG. 9 is a schematic view illustrating the step of removing the shoe tree from the receiving space.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

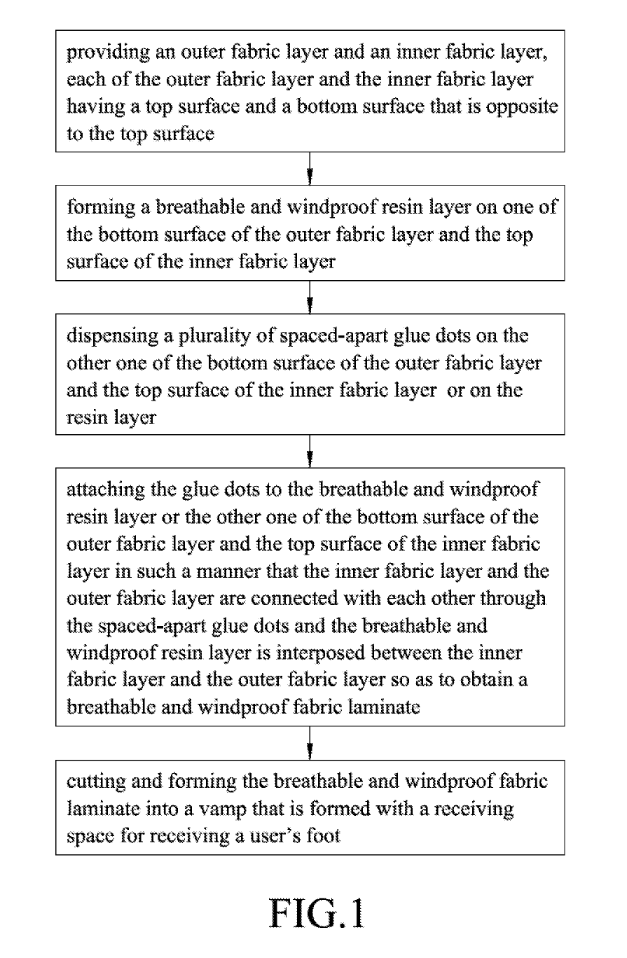

FIG. 1 shows the embodiment of a method of making a breathable and windproof vamp for a shoe according to the disclosure, which includes the steps of (a) fabric layer-providing step, (b) resin layer forming step, (c) glue-dots dispensing step; (d) fabric laminate forming step, and (e) vamp forming step.

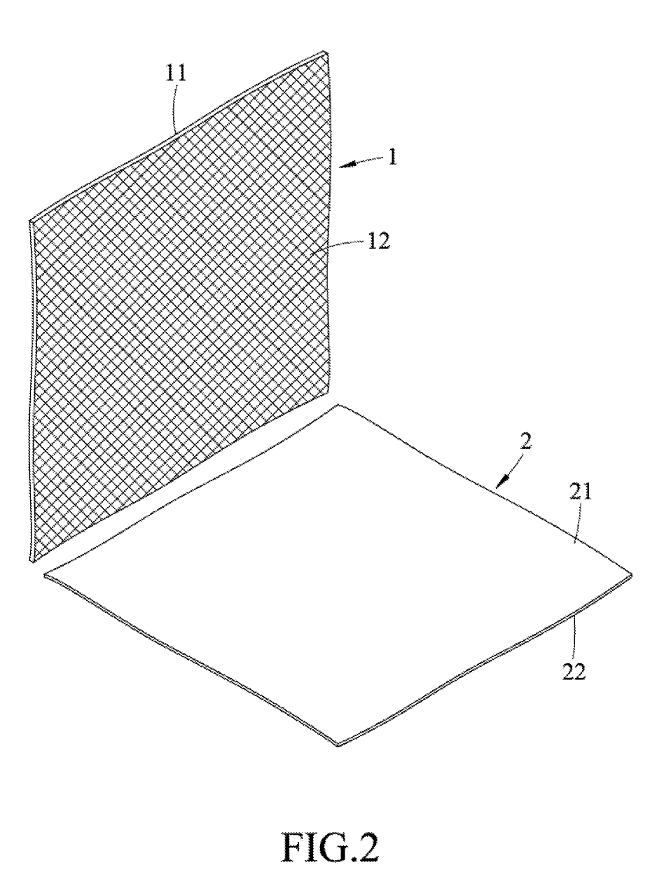

Referring to FIGS. 1 and 2, step (a) includes providing an outer fabric layer 1 and an inner fabric layer 2. Each of the outer fabric layer 1 and the inner fabric layer 2 has a top surface 11, 21 and a bottom surface 12, 22 that is opposite to the top surface 11, 21.

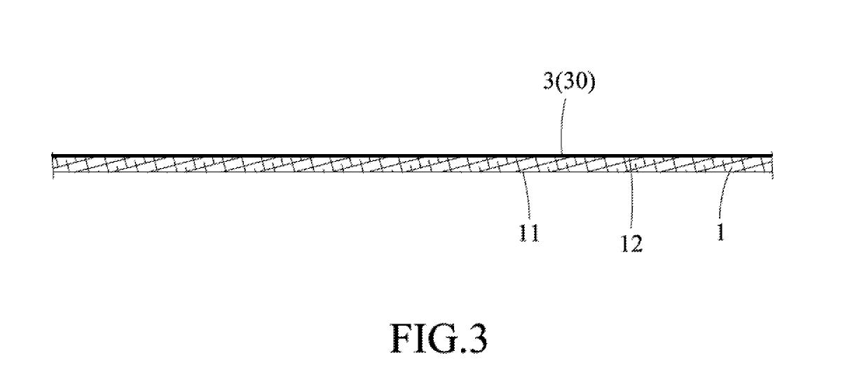

Referring to FIGS. 1 and 3, step (b) includes forming a breathable and windproof resin layer 30 on one of the bottom surface 12 of the outer fabric layer 1 and the top surface 21 of the inner fabric layer 2. The breathable and windproof resin layer 30 may be formed by coating a resin material on one of the bottom surface 12 of the outer fabric layer 1 and the top surface 21 of the inner fabric layer 2 to form a coating layer 3. In this embodiment, the resin material is coated on the bottom surface 12 of the outer fabric layer 1 to form the coating layer 3. The coating layer 3 is then dried to form the breathable and windproof resin layer 30. In certain embodiments, the outer fabric layer 1 may be placed in an oven (not shown) together with the coating layer 3 coated thereon at a predetermined heating temperature for a predetermined heating time to form the resin layer 30. In certain embodiments, the breathable and windproof resin layer 30 may have a thickness ranging from 10 μm to 50 μm. In certain embodiments, the breathable and windproof resin layer 30 includes polyurethane resin. In certain embodiments, the resin material may be polyurethane (PU) resin. The heating temperature and time may be adjusted based on the thickness of the breathable and windproof resin layer 30 and the composition of the resin material. For instance, the heating temperature and time may range from 50° C. to 180° C. and 1 minute to 5 minutes, respectively.

In certain embodiments, the resin layer 30 has an air permeability ranging from 0.1 CFM (ft³/min) to 10 CFM (ft³/min). Within this range, the breathable and windproof resin layer 30 has a better balance between the breathable and windproof effects. In certain embodiments, the resin layer 30 has an air permeability ranging from 0.5 CFM (ft³/min) to 5 CFM (ft³/min).

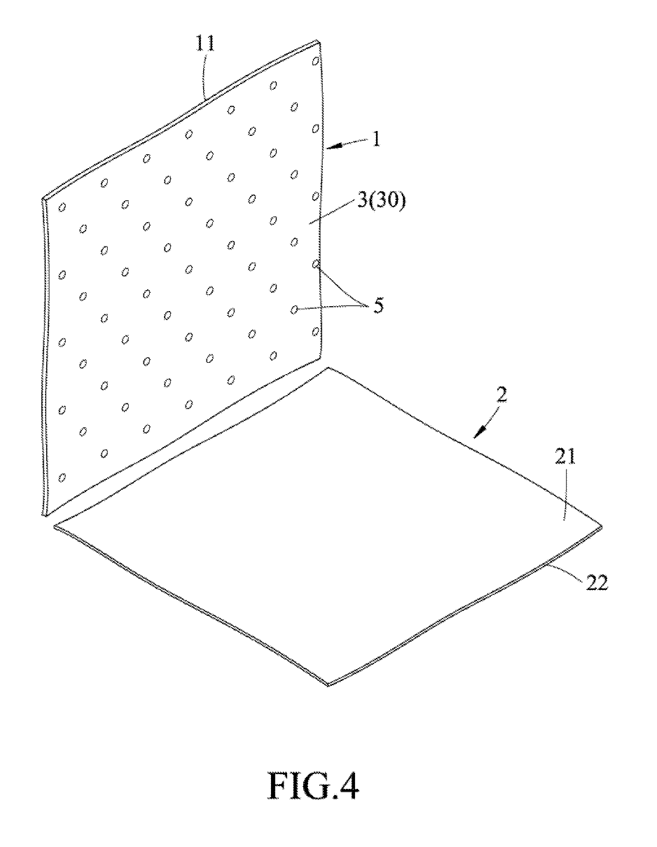

Referring to FIGS. 1 and 4, step (c) includes dispensing a plurality of spaced-apart glue dots 5 on the resin layer 30 or on the other one of the bottom surface 12 of the outer fabric layer 1 and the top surface 21 of the inner fabric layer 2. In this embodiment, the glue dots 5 are dispensed on the resin layer 30. The type of the glue is not particularly limited. In certain embodiments, the glue dots 5 include polyurethane reactive hot melt adhesive (PUR).

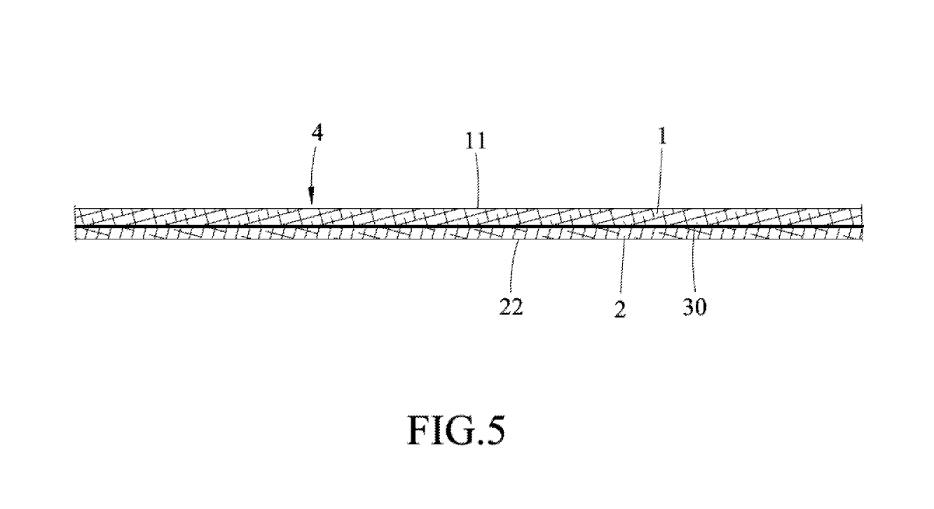

Referring to FIGS. 1 and 5, step (d) of the method of the disclosure includes connecting the inner fabric layer 2 and the outer fabric layer 1 in such a manner that the glue dots 5 and the breathable and windproof resin layer 30 are interposed between the inner fabric layer 2 and the outer fabric layer 1, and the inner fabric layer 2 and the outer fabric layer 1 are adhered with each other through the spaced-apart glue dots 5 so as to obtain a breathable and windproof fabric laminate 4. In certain embodiments, in the breathable and windproof fabric laminate, an area of the spaced-apart glue dots 5 ranges from 40% to 80% based on an area of the resin layer 30, thereby allowing the fabric laminate thus obtained to have good air permeability.

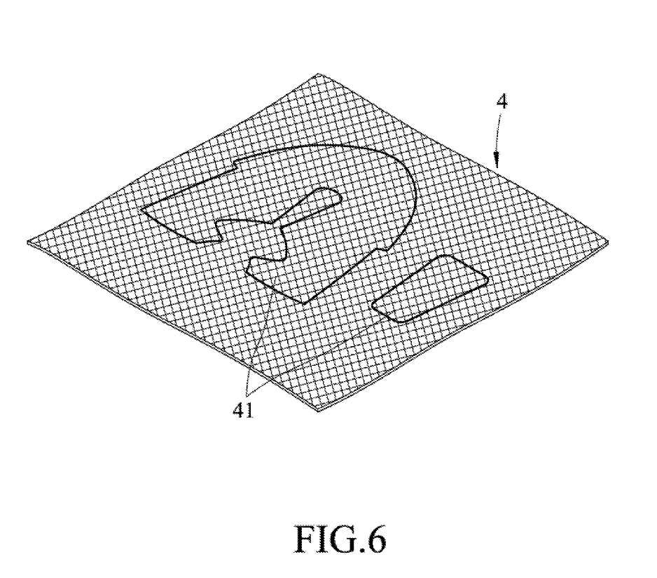

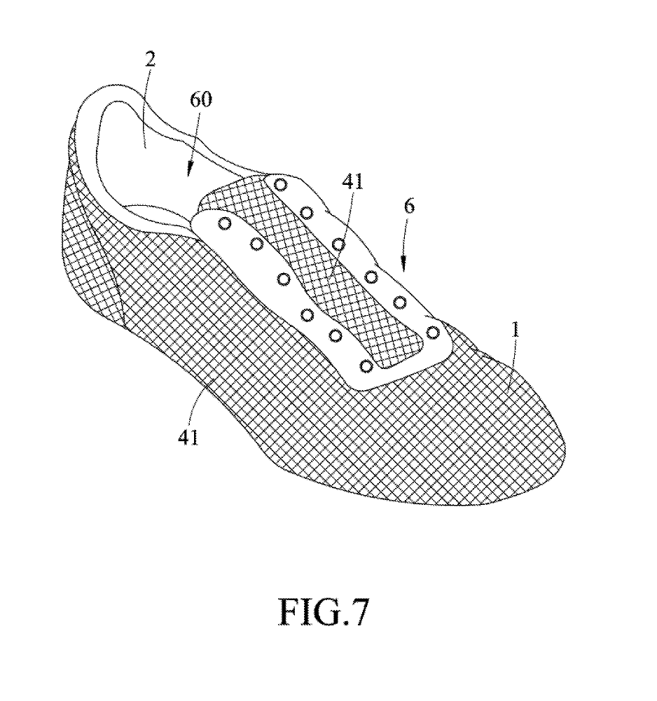

Referring to FIGS. 1, 6 and 7, step (e) of the method of the disclosure includes cutting and forming the breathable and windproof fabric laminate 4 into a vamp 6. To be specific, the breathable and windproof fabric laminate 4 is cut into a plurality of vamp-making pieces 41 and the vamp-making pieces 41 are sewn together to form a vamp 6. The vamp 6 is formed with a receiving space 60 for receiving a user's foot.

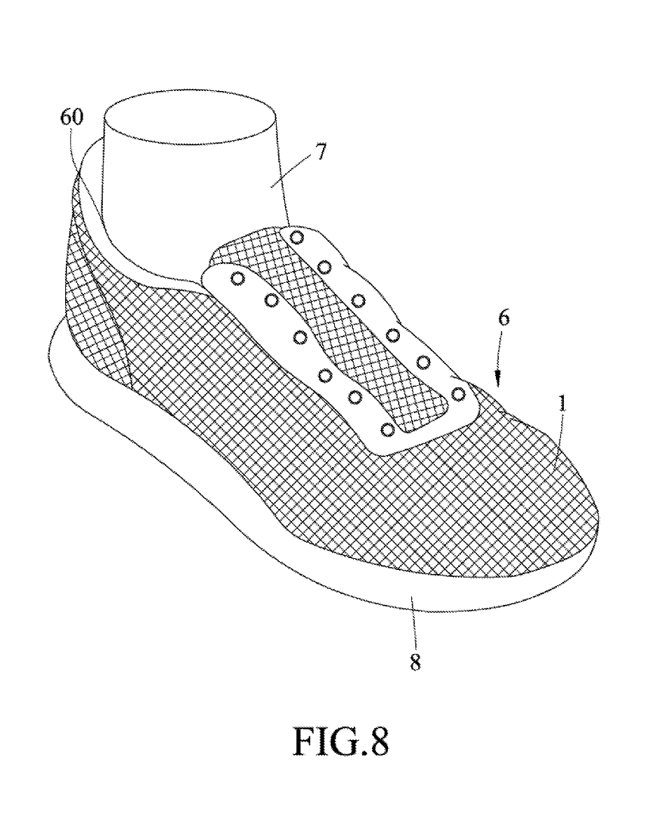

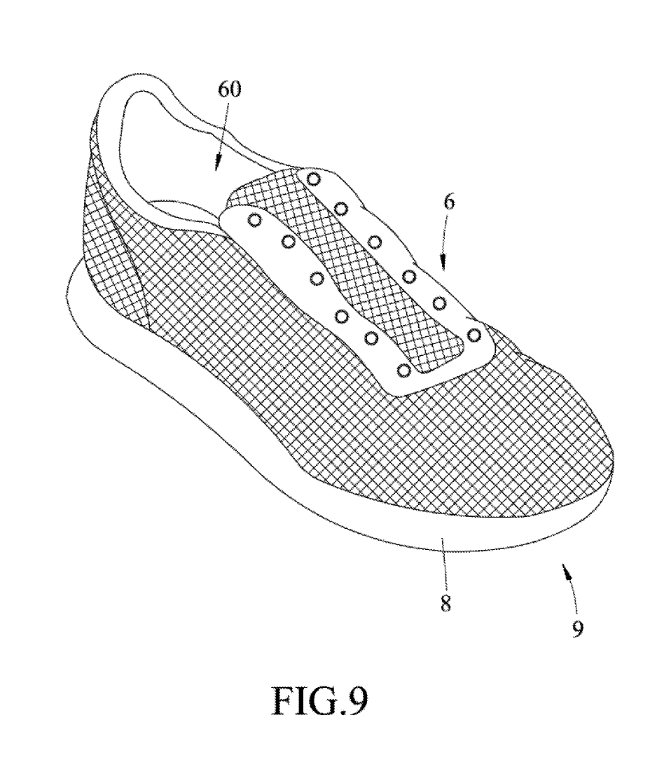

The disclosure also provides an embodiment of a method of making a shoe. The method includes preparing the abovementioned breathable and windproof vamp 6, disposing a shoe tree 7 in the receiving space 60 of the vamp 6 for maintaining a configuration of the vamp 6 (see FIG. 8), then attaching a shoe sole 8 to a bottom of the vamp 6, and then removing the shoe tree 7 from the receiving space 60 (see FIG. 9).

It should be noted that, if the outer fabric layer 1 is made from a fabric having relatively large pore size, it would be difficult to form the breathable and windproof resin layer 30 on the bottom surface 12 of the outer fabric layer 1. Thus, the breathable and windproof resin layer 30 can be formed on the top surface of the inner fabric layer 2. The spaced-apart glue dots 5 may be dispensed on the bottom surface 12 of the outer fabric layer 1.

In certain embodiments, the top surface 11 of the outer fabric layer 1 in step (a) is subjected to a water repellent treatment to improve the waterproof property of the vamp 6.

In summary, with the breathable and windproof resin layer 30 and the spaced-apart glue dots 5, the vamp 6 of the shoe of this disclosure is lightweight, breathable and windproof.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of making a breathable and windproof vamp (6) for a shoe, comprising:
(a) providing an outer fabric layer and an inner fabric layer, each of the outer fabric layer and the inner fabric layer having a top surface and a bottom surface that is opposite to the top surface;
(b) forming a breathable and windproof resin layer on one of the bottom surface of the outer fabric layer and the top surface of the inner fabric layer;
(c) dispensing a plurality of spaced-apart glue dots on the resin layer or on the other one of the bottom surface of the outer fabric layer and the top surface of the inner fabric layer;
(d) connecting the inner fabric layer and the outer fabric layer in such a manner that the glue dots and the breathable and windproof resin layer are interposed between the inner fabric layer and the outer fabric layer, and the inner fabric layer and the outer fabric layer are adhered with each other through the spaced-apart glue dots so as to obtain a breathable and windproof fabric laminate; and
(e) cutting and forming the breathable and windproof fabric laminate into a vamp that is formed with a receiving space for receiving a user's foot.

2. The method of claim 1, wherein in the breathable and windproof fabric laminate, an area of the spaced-apart glue dots ranges from 40% to 80% based on an area of the resin layer.

3. The method of claim 1, wherein the breathable and windproof resin layer includes polyurethane resin.

4. The method of claim 1, wherein step (b) is conducted by coating a resin material on one of the bottom surface of the outer fabric layer and the top surface of the inner fabric layer to form a coating layer, and drying the coating layer.

5. The method of claim 4, wherein the resin material includes polyurethane resin.

6. The method of claim 4, wherein the coating layer is dried at a temperature ranging from 50° C. to 180° C. for 1 minute to 5 minutes.

7. The method of claim 1, wherein the glue dots include polyurethane reactive hot melt adhesive.

8. The method of claim 1, wherein the top surface of the outer fabric layer in step (a) is subjected to a water repellent treatment.

9. The method of claim 1, wherein the resin layer has an air permeability ranging from 0.1 CFM (ft³/min) to 10 CFM (ft³/min).

10. The method of claim 1, wherein the resin layer has a thickness ranging from 10 μm to 50 μm.

11. A method for making a breathable and windproof shoe, comprising:
preparing a breathable and windproof vamp according to the method of claim 1; and
disposing a shoe tree in the receiving space of the vamp for maintaining a configuration of the vamp;
attaching a shoe sole to a bottom of the vamp; and
removing the shoe tree from the receiving space.
